(19) United States
(12) Patent Application Publication
(10) Pub. No.: US 2016/0137233 A1
(43) Pub. Date: May 19, 2016

(54) ALUMINUM ALLOY FOR VEHICLE OUTER PANELS AND METHOD FOR PRODUCING THE SAME

(71) Applicant: HYUNDAI MOTOR COMPANY, Seoul (KR)

(72) Inventor: Hoon Mo Park, Seongnam (KR)

(21) Appl. No.: 14/708,256

(22) Filed: May 10, 2015

(30) Foreign Application Priority Data
Nov. 19, 2014 (KR) 10-2014-0161585

(51) Int. Cl. B62D 29/00; C22C 21/08; C22C 21/00; B22D 21/04; B22D 27/08

(52) U.S. Cl. CPC B62D 29/008; B22D 21/04; B22D 27/08; C22C 21/00; C22C 21/08

(57) ABSTRACT

Disclosed herein are an aluminum alloy for vehicle outer panels and a method for producing the aluminum alloy thereby improving elasticity, formability, and dent resistance by maximizing a generation of boride compound to improve stiffness and NVH characteristics. The aluminum alloy for vehicle outer panels includes Ti, B, Mg, and a balance of the aluminum alloy being Al and includes both of an AlB₂ phase and a TiB₂ phase as a reinforcing phase. In particular, a composition ratio of Ti:B:Mg is of about 1:about 2.0-2.5:about 5.0-6.0 and B is included in an amount of about 1.1 to 2.5 wt % based on the total weight of the alloy composition.

### CROSS REFERENCE TO RELATED APPLICATION

The present application claims priority to Korean Patent Application No. 10-2014-0161585, filed Nov. 19, 2014, the entire contents of which is incorporated herein for all purposes by this reference.

### TECHNICAL FIELD

The present invention relates to an aluminum alloy for vehicle outer panels and a method for producing the aluminum alloy. The aluminum alloy for vehicle outer panels and a method for producing the aluminum alloy may improve elasticity, formability, and dent resistance by maximizing a generation of boride compound thereby improving stiffness, and noise vibration and harshness (NVH) characteristics.

### BACKGROUND OF THE INVENTION

Generally, an aluminum alloy has been made to improve aluminum property to provide improved characteristics.

A high tensile aluminum alloy, for example, duralumin, which is produced by adding copper to aluminum has improved strength. Super duralumin has been produced by adding magnesium to duralumin, and extra super duralumin has been produced by adding zinc thereto has been used as an aircraft material.

However, the high tensile aluminum alloy may have a problem of corrosion resistance. An aluminum architectural alloy in which magnesium and zinc are added has excellent corrosion resistance and thus has been used for railway vehicles, bridge, and the like. As an aluminum alloy for casting, an alloy in which silicon is added has been used. Further, other aluminum alloys have been combined with other metals to be used for other purposes, such as heat resistance and luminosity.

The aluminum alloy may be classified into a wrought purpose alloy and a casting purpose alloy. As the aluminum alloy for the wrought purpose, examples may include Al—Cu—Mg based aluminum alloy (e.g. duralumin, super duralumin), Al—Mn based aluminum alloy, Al—Mg—Si based aluminum alloy, Al—Mg based aluminum alloy, Al—Zn—Mg based aluminum alloy (extra super duralumin), and the like. As the aluminum alloy for casting purpose, examples may include Al—Cu based aluminum alloy, Al—Si based aluminum alloy (e.g. silumin), Al—Cu—Si based aluminum alloy (e.g. lautal), Al—Mg based aluminum alloy (e.g. hydronalium), Al—Cu—Mg—Si based aluminum alloy (e.g. Y alloy), Al—Si—Cu—Mg—Ni based aluminum alloy (e.g. Lo-Ex alloy), and the like.

In the related art, a reinforcing phase, such as metal-based compound or CNT, has been formed in a powder form to improve the elasticity of the aluminum alloy, but may have a limitation in price competitiveness.

Further, technical difficulties of loss, wettability, and dispersion in Al molten metal have occurred when the reinforcing phase is injected in the power form in the casting process. When the reinforcing phase is added without improving a base alloy and the reinforcing phase is substantially added just to achieve the targeted elasticity, manufacturing cost may increase, and process may not be controlled easily.

Therefore, a need exists for a technology for maximizing a generation of boride compound which plays the most important role in improving the elasticity and for uniformly dispersing the boride compound generated by a spontaneous reaction in the aluminum molten metal.

An aluminum alloy which may have improved elasticity over the conventional aluminum alloy without using an expensive material such as carbon nano tube (CNT) and may be applied in all the general casting processes including high-pressure casting has been introduced in detail in the related art.

However, such problems of loss, wettability, and dispersion in the Al molten metal at the time of injecting the reinforcing phase in the power form and the problems such as increased manufacturing cost and the difficulty in the process control due to substantial addition of the reinforcing phase have not been solved.

The matters described as the related art have been provided only for assisting in the understanding for the background of the present invention and should not be considered as corresponding to the related art known to those skilled in the art.

### SUMMARY OF THE INVENTION

In preferred aspects, the present invention provides an aluminum alloy for vehicle outer panels and a method for producing the aluminum alloy. As such, elasticity, formability, and dent resistance of the aluminum alloy may be improved by optimizing a composition ratio to maximize a generation of boride compound such as TiB₂ phase and AlB₂ phase as a reinforcing phase.

According to an exemplary embodiment of the present invention, provided is an aluminum alloy for vehicle outer panels. The aluminum alloy may include titanium (Ti), boron (B), magnesium (Mg), and a balance of the aluminum alloy being aluminum (Al), and in particular, may include both of an AlB₂ phase and a TiB₂ phase as a reinforcing phase. A composition ratio of Ti:B:Mg may be of about 1:about 2.0-2.5:about 5.0-6.0 based on the total weight of the aluminum alloy, in which Ti may be included in an amount of about 1 wt % or less and greater than 0 wt % based on the total weight of the aluminum alloy, and B may be included in an amount of about 1.1 to 2.5 wt % based on the total weight of the aluminum alloy.

The aluminum alloy may comprise: Mg in an amount of about 0.5 to 5 wt % based on the total weight of the aluminum alloy, Ti in an amount of about 0.55 to 1.0 wt % based on the total weight of the aluminum alloy, B in an amount of about 1.1 to 2.5 wt % based on the total weight of the aluminum alloy, and the balance of the aluminum alloy being Al. Further, the composition ratio of Ti:B:Mg may be of about 1:about 2.0-2.5:about 5.0-6.0, and the aluminum alloy may include the AlB₂ phase, the TiB₂ phase, and MgB₂ phase as the reinforcing phase.

The present invention further provides an aluminum alloy composition that may consist of or consist essentially of the components in the above aluminum alloy composition. For instance, the aluminum alloy may consist of or consist essentially of: Mg in an amount of about 0.5 to 5 wt % based on the total weight of the aluminum alloy, Ti in an amount of about 0.55 to 1.0 wt % based on the total weight of the aluminum alloy, B in an amount of about 1.1 to 2.5 wt % based on the total weight of the aluminum alloy, and the balance of the aluminum alloy being Al. In particular, the composition ratio of Ti:B:Mg may be of about 1:about 2.0-2.5:about 5.0-6.0, and the aluminum alloy may include the AlB₂ phase, the TiB₂ phase, and MgB₂ phase as the reinforcing phase.

According to another exemplary embodiment of the present invention, provided is a method for producing an aluminum alloy for vehicle outer panels. The method may include: charging, in a melting vessel such as a furnace, at least one from an Al—Ti master alloy, an Al—B master alloy, and an Al salt compound in an Al molten metal containing Mg in an amount of 0.5 to 5 wt % to form a molten metal; and agitating the molten metal by using an agitator to disperse an AlB₂ phase and a TiB₂ phase that may be generated as a reinforcing phase by a spontaneous reaction. In particular, in the charging step, a composition ratio of Ti:B:Mg may be of about 1:about 2.0-2.5:about 5.0-6.0.

The agitator may be formed to have a length of about 0.4 times or greater of a diameter of the melting vessel and in the agitating, the molten metal may be agitated at a speed of about 500 rpm or greater.

The Al—Ti master alloy may include Ti in an amount of about 5 to 20 wt % based on the total weight of the Al—Ti master alloy and a balance of the Al—Ti alloy being Al.

The Al—B master alloy may include B in an amount of about 3 to 10 wt % based on the total weight of the Al—B master alloy and a balance of the Al—B alloy being Al.

The Al salt compound may include aluminum salts in an amount of about 75 wt % based on the total weight of the compound. Further provided are vehicle outer panels that may comprise the aluminum alloy as described herein.

Other aspects of the present invention are disclosed infra.

### BRIEF DESCRIPTION OF THE DRAWINGS

The above and other objects, features and advantages of the present invention will be more clearly understood from the following detailed description taken in conjunction with the accompanying drawings, in which:

FIG. 1 illustrates characteristics for exemplary reinforcing phases and elasticity contribution depending on the characteristics.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, exemplary embodiments of the present invention will be described in detail with reference to the accompanying drawings. However, the present invention is not limited to these exemplary embodiments. For reference, the reference numerals in the present specification will be used to describe substantially the same components. Under this rule, a description may be provided while citing a content shown in other drawings and a content well-known to those skilled in the art or a repeated content may be omitted.

An aluminum alloy for vehicle outer panels according to an exemplary embodiment of the present invention may include an AlB₂ phase and a TiB₂ phase as a reinforcing phase to simultaneously improve elasticity, formability, and dent resistance.

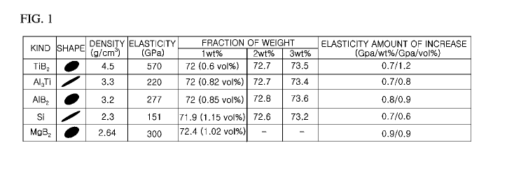

FIG. 1 illustrates characteristics of exemplary reinforcing phases and elasticity contribution depending on the characteristics using a Digimat program.

As illustrated in FIG. 1, the elasticity contribution may be determined simply by elasticity of a reinforcing phase itself as well as by a composite action of a shape and a density of the reinforcing phase, and the like. For example, although the elasticity of the reinforcing phase itself is greater than others, an increase rate in elasticity may be changed depending on other characteristics such as density.

Further, the present invention relates to an aluminum alloy for vehicle outer panels. Such aluminum alloy needs to have excellent elasticity, formability, and dent resistance to improve stiffness and NVH characteristics and a weight thereof needs to be reduced to thereby reduce a weight of a vehicle body.

Therefore, when elasticity of a reinforcing phase itself as well as a shape, a density, and the like thereof are considered in combination, a TiB₂ phase, an AlB₂ phase, a MgB₂ phase, and the like may be suitable as reinforcing phases since those may have a spherical shape and have a relatively greater elasticity rate of increase.

The aluminum alloy for vehicle outer panels according to an exemplary embodiment of the present invention may include Mg in an amount of about 0.5 to 5 wt % based on the total weight of the aluminum alloy, T in an amount of about 0.55 to 1.0 wt % based on the total weight of the aluminum alloy, B in an amount of about 1.1 to 2.5 wt % based on the total weight of the aluminum alloy and the balance of the aluminum alloy being Al. Particularly, a composition ratio of Ti:B:Mg may be of about 1:about 2.0-2.5:about 5.0-6.0.

The aluminum alloy of the present invention may be an Al—Mg-based aluminum alloy, in which the contents of Ti and B is adjusted. The Al—Mg-based aluminum alloy may have a casting temperature similar to that of a commercial 5000 series aluminum alloy in which Mg in an amount of about 0.5 to 5 wt % based on the total weight of the aluminum alloy is contained, but the Al—Mg-based aluminum alloy of the present invention may simultaneously improve elasticity, formability, and dent resistance greater than the commercial 5000 series aluminum alloy.

Generally, the commercial 5000 series aluminum alloy has been mainly used as the vehicle outer panels. The aluminum alloy for vehicle outer panels according to an exemplary embodiment of the present invention may be based on a composition component of the commercial 5000 series aluminum alloy which is mainly used as the vehicle outer panel. Thus, the aluminum alloy of an exemplary embodiment may include Ti, B, and Mg, in particular, a composition ratio of Ti:B:Mg may have a ratio of about 1:about 2.0-2.5:about 5.0-6.0 as a weight ratio.

Generally, when Ti and B are added to aluminum, TiB₂ and Al₃Ti reinforcing phases may be formed to substantially contribute to elasticity. When the composition ratio of Ti:B:Mg is about 1:about 2.0-2.5:about 5.0-6.0 as a weight ratio, the reinforcing phases may have a shape of an elliptical ball in which a difference between a major axis and a minor axis is large. Thus, the reinforcing phases may be generated as of the AlB₂ phase and the TiB₂ phase while minimizing a generation of Al₃Ti phase which reduces formability of a material. Further, the remaining B may react with Mg to additionally generate the MgB₂ phase as the reinforcing phase, thereby simultaneously improving the elasticity, the formability, and the dent resistance.

TABLE 1

| | | | | | | | | | | | | | Latent | Tensile | Yield | Yield/ | Tensile/ | Melting |
|---|---|---|---|---|---|---|---|---|---|---|---|---|---|---|---|---|---|---|
| | | | | | | | | | | | Modulus | DAS | Heat | Strength | Strength | Tensile | Yield | Point |
| Ti:B:Mg | Si | Fe | Cu | Mn | Mg | Cr | Zn | Ti | B | Al | Gpa | μm | J/g | MPa | MPa | Ratio | Difference | ° C. |
| 1:1.1:2 | 0.25 | 0.4 | 0.1 | 0.1 | 2 | 0.1 | 0.1 | 1 | 1.1 | Bal. | 70 | 23 | 380 | 409 | 289 | 71 | 120 | 640 |
| 1:1.1:3 | 0.25 | 0.4 | 0.1 | 0.1 | 3 | 0.1 | 0.1 | 1 | 1.1 | Bal. | 71 | 23 | 381 | 403 | 283 | 70 | 120 | 642 |
| 1:1.1:4 | 0.25 | 0.4 | 0.1 | 0.1 | 4 | 0.1 | 0.1 | 1 | 1.1 | Bal. | 70 | 18 | 371 | 424 | 304 | 72 | 120 | 630 |
| 1:1.1:5 | 0.25 | 0.4 | 0.1 | 0.1 | 5 | 0.1 | 0.1 | 1 | 1.1 | Bal. | 73 | 18 | 372 | 424 | 304 | 72 | 120 | 635 |
| 1:2.3:2 | 0.25 | 0.4 | 0.1 | 0.1 | 2 | 0.1 | 0.1 | 1 | 2.3 | Bal. | 73 | 25 | 373 | 488 | 369 | 76 | 119 | 648 |
| 1:2.3:3 | 0.25 | 0.4 | 0.1 | 0.1 | 3 | 0.1 | 0.1 | 1 | 2.3 | Bal. | 72 | 20 | 327 | 680 | 583 | 86 | 97 | 642 |
| 1:3:3 | 0.25 | 0.4 | 0.1 | 0.1 | 3 | 0.1 | 0.1 | 1 | 3 | Bal. | 75 | 23 | 363 | 533 | 418 | 78 | 115 | 641 |
| 1:2.3:4 | 0.25 | 0.4 | 0.1 | 0.1 | 4 | 0.1 | 0.1 | 1 | 2.3 | Bal. | 72 | 18 | 361 | 515 | 398 | 77 | 117 | 630 |
| 1:2:5 | 0.25 | 0.4 | 0.1 | 0.1 | 5 | 0.1 | 0.1 | 1 | 2 | Bal. | 74 | 18 | 362 | 490 | 372 | 76 | 120 | 630 |
| 1:2.3:5 | 0.25 | 0.4 | 0.1 | 0.1 | 5 | 0.1 | 0.1 | 1 | 2.3 | Bal. | 73 | 19 | 355 | 497 | 378 | 76 | 119 | 630 |
| 1:2.5:5 | 0.25 | 0.4 | 0.1 | 0.1 | 5 | 0.1 | 0.1 | 1 | 2.5 | Bal. | 74 | 19 | 353 | 510 | 392 | 77 | 118 | 630 |
| 1:2.3:6 | 0.25 | 0.4 | 0.1 | 0.1 | 6 | 0.1 | 0.1 | 1 | 2.3 | Bal. | 74 | 17 | 352 | 523 | 393 | 75 | 130 | 625 |
| 2.3:1.1:2 | 0.25 | 0.4 | 0.1 | 0.1 | 2 | 0.1 | 0.1 | 2.3 | 1.1 | Bal. | 71 | 22 | 378 | 411 | 291 | 71 | 120 | 640 |
| 2.3:1.1:3 | 0.25 | 0.4 | 0.1 | 0.1 | 3 | 0.1 | 0.1 | 2.3 | 1.1 | Bal. | 72 | 22 | 378 | 406 | 286 | 70 | 120 | 642 |

TABLE 2

| | Fraction of Reinforcing Phase | | | | | | | | |
|---|---|---|---|---|---|---|---|---|---|
| | | | | | | | | AlCr | |
| | TiB₂ | | | | | | | Mg | AlCu |
| Ti:B:Mg | MgB₂ | AlB₂ | Al₃Ti | Al₃Mg₂ | Al₃Fe | Mg₂Si | Al₆Mn | Mn | MgZn |
| 1:1:1 | 1.45 | 1.46 | — | — | — | 0.68 | 2.18 | 0.67 | — |
| 1:2.5:2.5 | 1.45 | 4.6 | — | — | 0.83 | 0.68 | 0.51 | 0.82 | 0.53 |
| 1:2:4 | 1.45 | 3.48 | — | 10.1 | 0.96 | 0.68 | 0.14 | 1.07 | 0.53 |
| 1:2.5:5 | 1.45 | 4.6 | — | 4.1 | 0.96 | 0.68 | 0.14 | 1.07 | 0.53 |
| 1:2.5:7 | 1.45 | 4.6 | — | 10.2 | 0.96 | 0.68 | 0.14 | 1.07 | 0.53 |

Table 1 shows a change in physical properties of the 5000 series aluminum alloy depending on the composition ratio of Ti:B:Mg according to exemplary embodiments of the present invention at initial cooling speed of 50° C./s and Table 2 shows a fraction of reinforcing phases depending on the composition ratio of Ti:B:Mg according to exemplary embodiments of the present invention.

As shown in Tables 1 and 2, when a content of B is equal to or greater than about 1.1 wt % based on the total weight of the aluminum alloy, or alternatively, is about a threshold at which the AlB₂ phase and the TiB₂ phase may be simultaneously generated and the composition ratio of Ti:B:Mg according to the exemplary embodiment of the present invention is satisfied, modulus may be equal to or greater than about 73 GPa, DAS representing the formability may be equal to or less than about 19 μm, a ratio of yield/tensile strength may be equal to or greater than about 75, and a tensile/yield difference may be equal to or greater than about 110, and the elasticity, the formability, and the dent resistance may be substantially improved over other alloys.

In particular, in the aluminum alloy for vehicle outer panels according to the exemplary embodiment of the present invention, the content of Ti may be in an amount of about 1.0 wt % or less based on the total weight of the aluminum alloy and the content of B may be in an amount of about 1.1 to 2.5 wt % based on the total weight of the aluminum alloy.

When the content of B is less than about 1.1 wt %, a generation quantity of AlB₂ phase may be reduced and only the TiB₂ phase may be generated and thus the improvement in elasticity may not be sufficient. When the content of B is greater than about 1.1 wt % and the content of Mg is less than about 5 wt %, the strength may be increased and thus the dent resistance may be improved, however, the elasticity and the formability may be reduced. When the content of Mg is greater than about 6 wt %, a melting point may be equal to or greater than about 800° C. and thus a large amount of oxidation inclusion may be generated in molten metal at the time of applying the actual casting process and a gas concentration within the molten metal may be increased thereby deteriorating an internal quality of casting product.

Meanwhile, when the content of Ti is greater than about 1.0 wt %, the Al₃Ti phase having a shape of an elliptical ball may be generated and thus the other physical properties excepting a tensile/yield difference become to be not satisfied, thereby deteriorating the elasticity, the formability, and the dent resistance.

Further, the content of Mg may be added according to a composition ratio of Ti:B:Mg being about 1:about 2.0 to 2.5:about 5.0 to 6.0 based on the total weight of the aluminum alloy. When the content of Mg is greater than the amount according to the composition ratio of Ti:B:Mg being about 1:about 2.0 to 2.5:about 5.0 to 6.0, the Al₃Mg₂ having a shape of an elliptical ball may be generated and thus the formability may be reduced.

TABLE 3

| | | | | | | | Tensile/ | Melt- |
|---|---|---|---|---|---|---|---|---|
| | Mod- | | Latent | Tensile | Yield | Yield/ | Yield | ing |
| | ulus | DAS | Heat | Strength | Strength | Tensile | Differ- | Point |
| | GPa | μm | J/g | Mpa | Mpa | Ratio | ence | ° C. |
| 5023 | 69.4 | 17.3 | 338 | 322 | 210 | 65 | 112 | 632 |
| 5052 | 68 | 24.5 | 393 | 291 | 184 | 63 | 107 | 646 |
| 5083 | 70 | 19 | 387 | 315 | 204 | 65 | 111 | 633 |

Table 3 shows physical properties of the existing 5000 series aluminum.

As shown in Tables 1 to 3, when the composition ratio of Ti:B:Mg is about 1:about 2.0-2.5:about 5.0 to 6.0 according to exemplary embodiments of the present invention, the formability thereof may be comparable to a conventional material, the elasticity may be increased by about 6% or greater and the dent resistance (yield/tensile ratio) may be increased by about 15%.

As such, the aluminum alloy for vehicle outer panels according to exemplary embodiments of the present invention may substantially improve the stiffness and NVH characteristics of parts over the conventional 5000 series aluminum and minimize the reinforcement design at the time of producing the vehicle, thereby reducing a weight of a vehicle body and saving manufacturing costs.

Further, a method for producing an aluminum alloy for vehicle outer panels is provided. The method may include: charging, in a melting vessel such as a furnace, at least one from an Al—Ti master alloy, an Al—B master alloy, and an Al salt compound in a commercial 5000 series Al molten metal containing Mg in an amount of 0.5 to 5 wt % to form a molten metal; and agitating the molten metal to disperse the AlB₂ phase and the TiB₂ phase that are generated as the reinforcing phases.

In the charging, the composition ratio of Ti:B:Mg in the molten metal may be about 1:about 2.0-2.5:about 5.0-6.0 by charging at least any one from the Al—Ti master alloy, the Al—B master alloy, and the Al salt compound. The Al—Ti master alloy charged in the molten metal may include Ti in an amount of about 5 to 20 wt % based on the total weight of the Al—Ti master alloy and the balance of the Al—Ti master alloy being Al, and the Al—B master alloy may include B in an amount of about 3 to 10 wt % based on the total weight of the Al—B master alloy and the balance of the Al—B master alloy being Al. The Al salt compound may include aluminum salts in an amount of about 75 wt % based on the total weight of the compound. As such, the TiB₂ phase and the AlB₂ phase may be simultaneously generated to improve the formability and the dent resistance while efficiently improving the elasticity, and further generation of Al₃Ti phase which is unfavorable to the formability and the shock property may be minimized.

In this case, the remaining B may react with Mg to additionally generate MgB₂ as a reinforcing phase, thereby improving the formability, the elasticity, and the dent resistance.

In the agitating, the molten metal may be agitated at a speed of about 500 rpm or greater by using an agitator having a length of about 0.4 times or greater of a diameter of the melting vessel such that the TiB₂ phase and the AlB₂ phase as the reinforcing phase may be uniformly dispersed as being simultaneously generated.

The length of the agitator and an agitating speed may affect the reaction speed and dispersion of the reinforcing phase. As such, the agitator of which the length is equal to or greater than 40% of the diameter of the melting vessel may be used.

When the agitating speed is less than about 500 rpm, the generation quantity of the TiB₂ phase may be insufficient while the Al₃Ti phase which is unfavorable to the formability and the shock property may be generated and thus the formability and the shock property are reduced and further, the generated reinforcing phase may not be uniformly dispersed in the molten metal and thus the deviation in physical properties depending on the molten metal site may be caused.

In the related arts, typical methods for producing aluminum have injected carbon nano tube or a reinforcing particle in a powder form to improve the elasticity. However, technical difficulties such as the loss, the wettability, the dispersion, and the like may occur in the molten metal, thereby increasing the manufacturing costs. On the other hand, according to an exemplary embodiment of the present invention, the composition ratio may be controlled to simultaneously generate the TiB₂ phase and the AlB₂ phase and uniformly disperse the generated TiB₂ phase and the AlB₂ phase in the molten metal while suppressing the generation of the Al₃Ti phase which is unfavorable to the formability and the shock property, thereby improving the elasticity, the formability, the dent resistance, and the like.

According to various exemplary embodiments of the present invention, the elasticity, the formability, and the dent resistance of the material may be simultaneously improved by optimizing the composition ratio of Ti, B, and Mg to maximize the generation of TiB₂ phase and AlB₂ phase as the reinforcing phases.

Further, the boride compound which is the reinforcing phase may be uniformly dispersed by agitating the TiB₂ phase and the AlB₂ phase that are generated by the spontaneous reaction in the aluminum molten metal at the optimum condition.

As described above, although the present invention has been described with reference to the exemplary embodiments thereof, those skilled in the art will appreciate that various modifications and alteration may be made without departing from the scope and spirit of the invention as disclosed in the accompanying claims.

What is claimed is:

1. An aluminum alloy for vehicle outer panels, comprising: titanium (Ti), boron (B), magnesium (Mg), and a balance of the aluminum alloy being aluminum (Al),
wherein the aluminum alloy includes both an AlB₂ phase and a TiB₂ phase as a reinforcing phase, a composition ratio of Ti:B:Mg is of about 1:about 2.0-2.5:about 5.0-6.0 based on the total weight of the aluminum alloy.

2. The aluminum alloy of claim 1, comprising,
wherein Ti is included in an amount of about 1 wt % or less and greater than 0 wt % based on the total weight of the aluminum alloy, and
B is included in an amount of about 1.1 to 2.5 wt % based on the total weight of the aluminum alloy.

3. The aluminum alloy of claim 1, consisting essentially of:
magnesium (Mg) in an amount of about 0.5 to 5 wt % based on the total weight of the aluminum alloy,
titanium (Ti) in an amount of about 0.55 to 1.0 wt % based on the total weight of the aluminum alloy,
boron (B) in an amount of about 1.1 to 2.5 wt % based on the total weight of the aluminum alloy, and
the balance of the aluminum alloy being Al,
wherein the composition ratio of Ti:B:Mg is about 1:about 2.0-2.5:about 5.0-6.0, and the aluminum alloy includes the AlB₂ phase, the TiB₂ phase, and a MgB₂ phase as the reinforcing phase.

4. A method for producing an aluminum alloy for vehicle outer panels, comprising:
charging, in a melting vessel, at least one from an aluminum-titanium (Al—Ti) master alloy, an aluminum-boron (Al—B) master alloy, and an aluminum (Al) salt compound in an aluminum (Al) molten metal containing Mg in an amount of 0.5 to 5 wt % to form a molten metal, a composition ratio of Ti:B:Mg is of about 1:about 2.0-2.5:about 5.0-6.0; and
agitating the molten metal by using an agitator to disperse an AlB₂ phase and a TiB₂ phase that are generated as a reinforcing phase by a spontaneous reaction.

5. The method of claim 4, wherein the agitator is formed to have a length of about 0.4 times or greater of a diameter of the melting vessel, and
in the agitating, the molten metal is agitated at a speed of about 500 rpm or greater.

6. The method of claim 4, wherein the Al—Ti master alloy includes Ti in an amount of about 5 to 20 wt % based on the total weight of the Al—Ti master alloy and a balance of the Al—Ti master alloy being Al.

7. The method of claim 4, wherein the Al—B master alloy includes B in an amount of about 3 to 10 wt % based on the total weight of the Al—B master alloy and a balance of the Al—B master alloy being Al.

8. The method of claim 4, the Al salt compound includes aluminum salts in an amount of about 75 wt % based on the total weight of the Al salt compound.

9. A vehicle outer panel that comprises aluminum alloy of claim 1.
